(19) United States
(12) Patent Application Publication
(10) Pub. No.: US 2022/0092685 A1
(43) Pub. Date: Mar. 24, 2022

(54) COLLABORATIVE STORAGE TECHNIQUES

(71) Applicant: International Business Machines Corporation, Armonk, NY (US)

(72) Inventors: Kimberly J. Taft, Austin, TX (US); Igor S. Ramos, Round Rock, TX (US); Angelo Danducci, II, Austin, TX (US); Devon E. Mensching, Austin, TX (US)

(21) Appl. No.: 17/028,260

(22) Filed: Sep. 22, 2020

(51) Int. Cl. G06Q 30/06; G06Q 10/10

(52) U.S. Cl. CPC G06Q 30/0645; G06Q 10/103

(57) ABSTRACT

In an approach for determining the optimal space to store goods as well as maximizing the amount of goods in a warehouse by facilitating peer-to-peer subletting of warehouse space, a processor receives a request for storage space from a first user, wherein the request includes a set of requirements for the storage space. A processor determines a suitable storage space for the first user based on the set of requirements. A processor generates a contract between the first user and a second user for the suitable storage space. A processor sends the contract to the first user and the second user while keeping each user anonymous to each other respective user. A processor determines whether the first user and the second user accepted the contract. A processor requests feedback from the first user and the second user about the contract.

### BACKGROUND OF THE INVENTION

The present invention relates generally to the field of product storage, and more particularly to collaborative storage techniques for determining the optimal space to store goods as well as maximizing the amount of goods in a warehouse.

Storage facilities, i.e., warehouses, play an important role in supply chain management for several reasons including being able to hold a wide assortment of products, to meet unanticipated demand, hold large shipping quantities, and to offer faster response by having additional storage facilities strategically located in different geographical areas.

Warehouses are the most common type of storage with five main types of warehouses. First, private warehouses are owned and operated by channel suppliers and resellers and used in their own distribution activity. For instance, a major retail chain may have several regional warehouses or “fulfillment centers” supplying their stores, or a wholesaler will operate a warehouse at which it receives and distributes products.

Second, public warehouses can be leased to solve short-term distribution needs. Retailers that operate their own private warehouses may occasionally seek additional storage space if their facilities have reached capacity or if they are making a special, large purchase of products. For example, retailers may order extra merchandise to prepare for in-store sales or order a large volume of a product that is offered at a low promotional price by a supplier.

Third, automated warehouses have levels of automation ranging from a small conveyor belt transporting products in a small area all the way up to a fully automated facility where only a few people are needed to handle storage activity for thousands of pounds/kilograms of product. In fact, many warehouses use machines to handle nearly all physical distribution activities, such as moving product-filled pallets (i.e., platforms that hold large amounts of product) around buildings that may be several stories tall and the length of two or more football fields. And the newest trend in warehouse automation is the use of warehouse robot technology, where small robots assist with product movement.

Fourth, climate-controlled warehouses are used for products that require special handling, such as freezers for storing frozen products, humidity-controlled environments for delicate products, including produce or flowers, and dirt-free facilities for handling highly sensitive computer products.

Fifth, distribution centers are warehouses that serve as points in the distribution system at which products are received from many suppliers and quickly shipped out to many customers. In some cases, such as with distribution centers handling perishable food (e.g., produce), most of the product enters in the early morning and is distributed by the end of the day.

### SUMMARY

Aspects of an embodiment of the present invention disclose a method, computer program product, and computer system for a collaborative leasing system, wherein the request includes a set of requirements for the storage space. A processor determines a suitable storage space for the first user based on the set of requirements. A processor generates a contract between the first user and a second user for the suitable storage space. A processor sends the contract to the first user and the second user while keeping each user anonymous to each other respective user. A processor determines whether the first user and the second user accepted the contract. A processor requests feedback from the first user and the second user about the contract.

In some aspects of an embodiment of the present invention, responsive to the first user opting into the collaborative leasing system, a processor requests first storage space information from the first user, wherein the first storage space information includes storage space preferences and first cost preferences. A processor creates a user profile for the first user with the first storage space information.

In some aspects of an embodiment of the present invention, responsive to the second user opting into the collaborative leasing system, a processor requests second storage space information from the second user, wherein the second storage space information includes an inventory of storage space available, preferences for each storage space, and second cost preferences. A processor creates a second user profile for the second user with the second storage space information.

In some aspects of an embodiment of the present invention, a processor determines the suitable storage space for the first user further based on the first storage space information and the second storage space information.

In some aspects of an embodiment of the present invention, a processor completes a cost assessment based on the first cost preferences and the second cost preferences.

In some aspects of an embodiment of the present invention, responsive to determining that the first user and the second user accepted the contract and upon completion of the contract, a processor requests the feedback from the first user and the second user, wherein the feedback requested includes feedback on the contract, the suitable storage space, and a respective other party to the contract.

In some aspects of an embodiment of the present invention, responsive to determining that at least one of the first user and the second user did not accept the contract, a processor requests the feedback from the at least one of the first user and the second user in the form of a reason for not accepting the contract. A processor uses the feedback to determine a second suitable storage space for the first user.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a setup component of collaborative storage program, in accordance with an embodiment of the present invention;

FIG. 3 is a flowchart depicting operational steps of a collaborative storage program, for determining the optimal space to store goods as well as maximizing the amount of goods in a warehouse by facilitating peer-to-peer subletting of warehouse space with dynamic pricing based on space, preferences, and demand on products, in accordance with an embodiment of the present invention; and

FIG. 4 depicts a block diagram of components of a computing device of the distributed data processing environment of FIG. 1, in accordance with an embodiment of the present invention.

### DETAILED DESCRIPTION

When storing products/goods in warehouses, there are certain trends, e.g., seasonal trends, companies consider when deciding the amount of product to store. However, there are certain trends that companies cannot predict. Supply chain disruptions like natural disasters or virus epidemics make it difficult to predict the amount of product a company should store in a warehouse and ultimately push to a store. For example, during a hurricane, grocery stores quickly run out of non-perishable food items and water. However, it is difficult to predict an exact location and time of where and when the hurricane will hit until right before it happens. Thus, there is a need for a solution for determining optimal warehouse usage during an unpredicted change in demand for certain products.

Embodiments of the present invention provide a solution for product storage when there is an extreme unpredicted spike in demand for certain products. Embodiments of the present invention provide a program that determines the optimal space to store goods as well as maximizing the amount of goods in a warehouse. Embodiments of the present invention utilize artificial intelligence (AI) to facilitate peer-to-peer subletting of warehouse space with dynamic pricing based on space, preferences, and demand on products. Company preferences may include, but are not limited to, a reliable person to rent from, cost requirements, weight restrictions, and temperature restrictions. Additionally, embodiments of the present invention provide real-time updates and replacement storage ideas, such as subdividing requested storage between multiple parties. The program acts as an arbitration system keeping the anonymity between parties involved. After a storage contract has ended, the program can receive feedback, i.e., cost and business impact on companies, from parties involved and adjust a next contract based on the feedback.

In a first use case, a hurricane is about to hit the Florida Keys, and as a result, the demand for bottled water owned by Drink Company A has skyrocketed while Drink Company B's soda products are in decreased demand. Drink Company A needs more space for the next week in south Florida warehouses to move more product and Drink Company B has extra space to rent out. Embodiments of the present invention set up an anonymous contract between the two companies and facilitate Drink Company B renting out space to Drink Company A for the next week.

In a second use case, Clothing Company A is utilizing 50% of a warehouse storage space right next to Department Store X and have swimsuits that typically don't sell much during the wintertime. Clothing Company B sells coats and are in need of more storage space after an especially cold beginning to winter. Embodiments of the present invention recognize the lack of movement of Clothing Company A's product and suggest they move it to a sister warehouse and rent out space to Clothing Company B.

Implementation of embodiments of the invention may take a variety of forms, and exemplary implementation details are discussed subsequently with reference to the Figures.

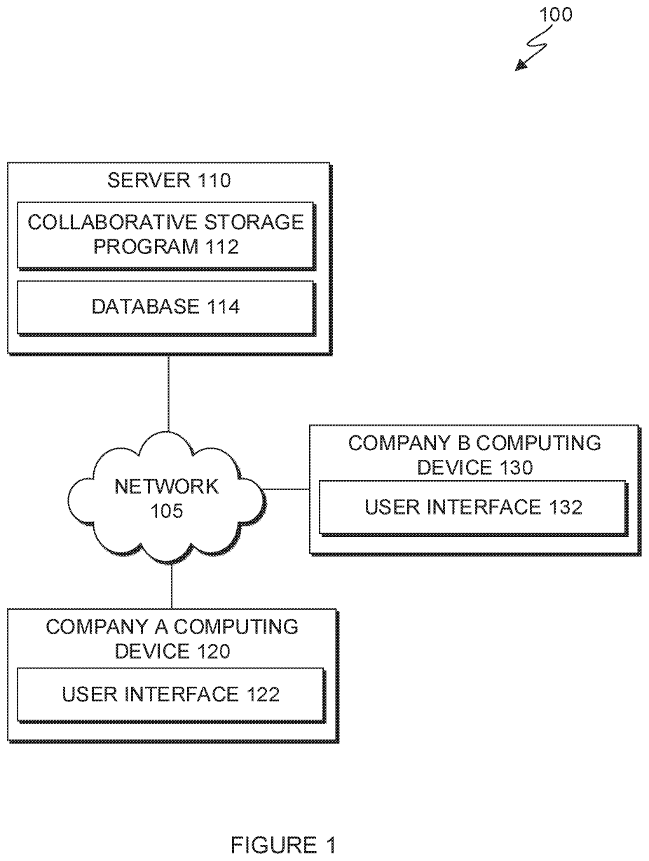

FIG. 1 is a functional block diagram illustrating a distributed data processing environment, generally designated 100, in accordance with one embodiment of the present invention. The term “distributed,” as used herein, describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server 110, company A computing device 120, and company B computing device 130, interconnected over network 105. Network 105 can be, for example, a telecommunications network, a local area network (LAN), a wide area network (WAN), such as the Internet, or a combination of the three, and can include wired, wireless, or fiber optic connections. Network 105 can include one or more wired and/or wireless networks capable of receiving and transmitting data, voice, and/or video signals, including multimedia signals that include voice, data, and video information. In general, network 105 can be any combination of connections and protocols that will support communications between server 110, company A computing device 120, company B computing device 130, and other computing devices (not shown) within distributed data processing environment 100.

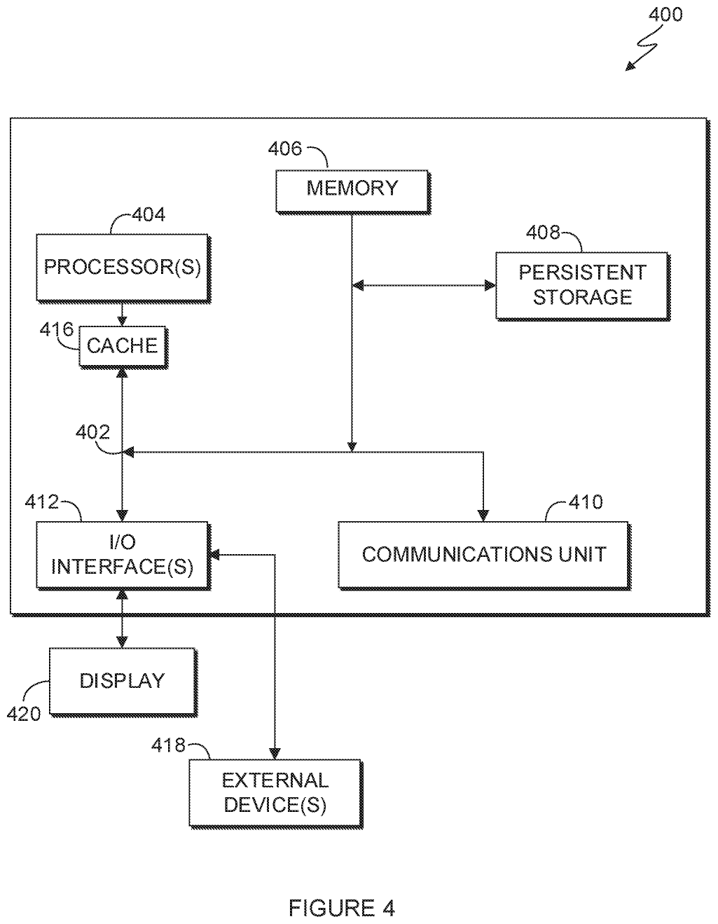

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any programmable electronic device capable of communicating with company A computing device 120, company B computing device 130, and other computing devices (not shown) within distributed data processing environment 100 via network 105. In another embodiment, server 110 represents a computing system utilizing clustered computers and components (e.g., database server computers, application server computers, etc.) that act as a single pool of seamless resources when accessed within distributed data processing environment 100. Server 110 includes collaborative storage program 112 and database 114. Server 110 may include internal and external hardware components, as depicted and described in further detail with respect to FIG. 4.

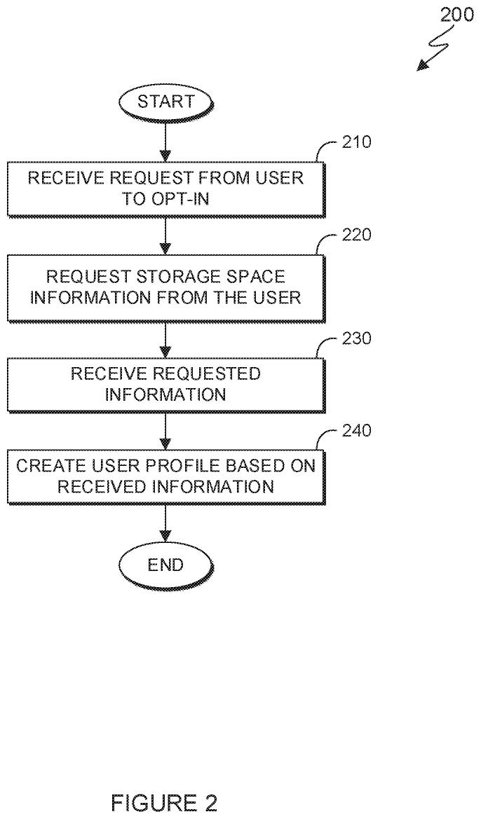

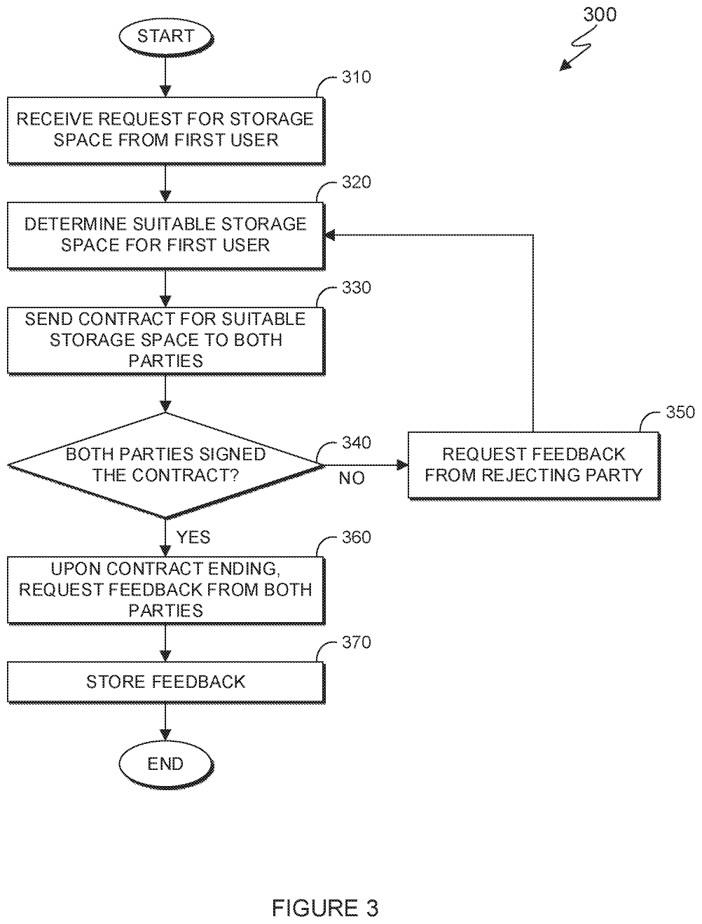

Collaborative storage program 112 operates to determine the optimal space to store goods as well as maximizing the amount of goods in a warehouse by facilitating peer-to-peer subletting of warehouse space with dynamic pricing based on space, preferences, and demand on products. In the depicted embodiment, collaborative storage program 112 is a standalone program. In another embodiment collaborative storage program 112 may be integrated into another software product, such as a product management or supply chain engine. In an embodiment, users, for example, product managers of companies, opt-in to the use of collaborative storage program 112 and set up a user profile or company profile with collaborative storage program 112. The setup component of collaborative storage program 112 is depicted and described in further detail with respect to FIG. 2. The main function of collaborative storage program 112, determining the optimal space to store goods as well as maximizing the amount of goods in a warehouse by facilitating peer-to-peer subletting of warehouse space with dynamic pricing based on space, preferences, and demand on products, is depicted and described in further detail with respect to FIG. 3.

Database 114 operates as a repository for data received, used, and/or output by collaborative storage program 112. Data received, used, and/or generated may include, but is not limited to, a plurality of user profiles with user profile information input by a user during setup about their inventory of storages space and storage space preferences; contracts that have been completed, ongoing, or not started, generated and sent to respective parties; feedback received from respective parties of a contract; and any other data received, used, and/or output by collaborative storage program 112. Database 114 can be implemented with any type of storage device capable of storing data and configuration files that can be accessed and utilized by server 110, such as a hard disk drive, a database server, or a flash memory. In an embodiment, database 114 is accessed by collaborative storage program 112 to store and/or to access the data. In the depicted embodiment, database 114 resides on server 110. In another embodiment, database 114 may reside on another computing device, server, cloud server, or spread across multiple devices elsewhere (not shown) within distributed data processing environment 100, provided that collaborative storage program 112 has access to database 114.

The present invention may contain various accessible data sources, such as database 114, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Collaborative storage program 112 enables the authorized and secure processing of personal data.

Collaborative storage program 112 provides informed consent, with notice of the collection of personal and/or confidential company data, allowing the user to opt in or opt out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Collaborative storage program 112 provides information regarding personal and/or confidential company data and the nature (e.g., type, scope, purpose, duration, etc.) of the processing. Collaborative storage program 112 provides the user with copies of stored personal and/or confidential company data. Collaborative storage program 112 allows the correction or completion of incorrect or incomplete personal and/or confidential company data. Collaborative storage program 112 allows for the immediate deletion of personal and/or confidential company data.

Company A computing device 120 and company B computing device 130 each operate as a computing device associated with a company, in which an employee user, such as a product manager, can opt-in to collaborative storage program 112 through a user interface. It is to be understood that company A computing device 120 and company B computing device 130 are representative of companies that have opted-in to collaborative storage program 112 and, in other embodiments, distributed data processing environment 100 may include any number of company computing devices that have opted-in. In the depicted embodiment, company A computing device 120 includes an instance of user interface 122 and company B computing device 130 includes an instance of user interface 132.

In an embodiment, company A computing device 120 and company B computing device 130 can each be a laptop computer, a tablet computer, a smart phone, a smart watch, a smart speaker, smart glasses, wearable computer, or any programmable electronic device capable of communicating with various components and devices within distributed data processing environment 100, via network 105. In general, company A computing device 120 and company B computing device 130 each represent one or more programmable electronic devices or combination of programmable electronic devices capable of executing machine readable program instructions and communicating with other computing devices (not shown) within distributed data processing environment 100 via a network, such as network 105. Company A computing device 120 and company B computing device 130 may include internal and external hardware components, as depicted and described in further detail with respect to FIG. 4.

User interfaces 122 and 132 each provides an interface between collaborative storage program 112 on server 110 and a user of company A computing device 120 and company B computing device 130, respectively. In one embodiment, user interfaces 122 and 132 are mobile application software. Mobile application software, or an “app,” is a computer program designed to run on smart phones, tablet computers and other mobile devices. In one embodiment, user interfaces 122 and 132 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program.

User interfaces 122 and 132 enable a user of company A computing device 120 and company B computing device 130, respectively, to create a company/user account for collaborative storage program 112, in which the user can input an inventory of available storage space including a description of each storage space and the user's preferences on usage of that storage space. Further, user interfaces 122 and 132 enable a user of company A computing device 120 and company B computing device 130, respectively, to opt-in or opt-out of collaborative storage program 112.

FIG. 2 is a flowchart 200 depicting operational steps of a setup component of collaborative storage program 112, on server 110 within distributed data processing environment 100 of FIG. 1, in accordance with an embodiment of the present invention. In an embodiment, collaborative storage program 112 completes a one-time setup with a user to create a user profile with collaborative storage program 112 for the user that is looking for storage space, has storage space, or both. The one-time setup allows collaborative storage program 112 to match a user in demand for storage space with a user that has available storage space. The term “user” can be used to represent an individual, a company employee, and/or a company. It should be appreciated that the process depicted in FIG. 2 illustrates one possible iteration of collaborative storage program 112, which may be repeated for each opt-in request received by collaborative storage program 112.

In step 210, collaborative storage program 112 receives a request from a user to opt-in. In an embodiment, collaborative storage program 112 receives a request from a user to opt-into collaborative storage program 112. For example, a product manager of Company A sends a request to opt-in to collaborative storage program 112 through user interface 122 of company A computing device 120.

In step 220, collaborative storage program 112 requests storage space information from the user. In an embodiment, collaborative storage program 112 requests information from the user depending on whether the user is looking for storage space to lease, looking to lease out storage space, or both. In an embodiment, responsive to collaborative storage program 112 receiving the request from the user to opt-in, collaborative storage program 112 requests storage space information from the user.

Information requested from a user who is looking for storage space to lease out can include, but is not limited to, storage space preferences and/or requirements (e.g., temperature requirements, location of storage space within storage facility, etc.) and cost preferences (i.e., a maximum cost the user is willing to spend on a storage space). For example, company X is looking for storage space for its perishable product, so company X requires a storage space with a refrigeration feature. In an embodiment, collaborative storage program 112 can also request a ranking of the preferences or a percentage of importance for each preference.

Information requested from a user who has storage space to lease out can include, but is not limited to, cost preferences, an inventory of storage space (available and unavailable), storage preferences and/or requirements for each storage space, and general contract information for current renters of each storage space that the user owns and/or operates. Cost preferences can include how much would the user is willing to sublet their storage space for. For example, John Smith can say he has X square feet of storage space available and won't accept a contract for less than $100 per day. In an embodiment, collaborative storage program 112 requests a description of each storage space including measurements (e.g., width, length, depth, cubic footage, or polygon definition of the space) of the space, expected storage temperature range, a maximum weight supported by the space, a height of the space with respect to a floor, and a location of the space within a storage facility. In an embodiment, collaborative storage program 112 requests storage preferences for each storage space. Storage preferences may include having a maximum weight preference, allowing perishables versus non-perishables, requiring fragile items to be in storage spaces closest to the floor.

In step 230, collaborative storage program 112 receives requested storage space information. In an embodiment, collaborative storage program 112 receives requested storage space information from the user. In an embodiment, responsive to collaborative storage program 112 requesting storage space information from the user, collaborative storage program 112 receives the storage space information from the user.

In step 240, collaborative storage program 112 creates a user profile based on the storage space information. In an embodiment, collaborative storage program 112 creates a user profile for the user and includes the storage space information received from the user. In an embodiment, collaborative storage program stores the user profile and/or the storage space information in a database, e.g., database 114. In an embodiment, responsive to collaborative storage program 112 receiving the storage space information from the user, collaborative storage program 112 creates the user profile based on the storage space information.

FIG. 3 is a flowchart 300 depicting operational steps of collaborative storage program 112, for determining the optimal space to store goods as well as maximizing the amount of goods in a warehouse by facilitating peer-to-peer subletting of warehouse space with dynamic pricing based on space, preferences, and demand on products, in accordance with an embodiment of the present invention. It should be appreciated that the process depicted in FIG. 3 illustrates one possible iteration of collaborative storage program 112, which may be repeated for each storage request received by collaborative storage program 112.

In step 310, collaborative storage program 112 receives a request for storage space from a first user. In an embodiment, collaborative storage program 112 receives a request from a first user for storage space with a set of requirements. The set of requirements may include, but are not limited to, location of preferred storage facility, a temperature of the storage space, a size of storage space needed, and a length of time the storage space is needed.

In step 320, collaborative storage program 112 determines a suitable storage space for the first user. In an embodiment, collaborative storage program 112 determines a suitable storage space for the first user based on the set of requirements in the request. In an embodiment, collaborative storage program 112 determines a suitable storage space for the first user based on the set of requirements compared against each user profile for users that have storage space to lease out, which includes inventory of available storage space and preferences for each storage space. In an embodiment, collaborative storage program 112 analyzes the available storage spaces (and the respective particulars/features of each storage space) against the first user's ranking of their preferences in their user profile to determine the most suitable storage space.

In an embodiment, collaborative storage program 112 completes a cost assessment as a component of determining the suitable storage space. The first user may indicate in their request or in their user profile that they are willing to pay more for a specific location of storage space and/or size of storage space. In an embodiment, collaborative storage program 112 completes a cost assessment based on the total inventory of storage space, each user's storage space preferences, and demand for the product that the first user is trying to store. In an embodiment, collaborative storage program 112 assesses how much the users with storage space currently charge to lease out a storage space. In an embodiment, collaborative storage program determines the suitable storage space based on the comparison of the set of requirements received in the first user's request against the storage spaces indicated in users' profiles and the cost assessment.

In an embodiment, collaborative storage program 112 determines if one user has a storage space that meets the first user's set of requirements. In an embodiment, if collaborative storage program 112 determines that one user does have a storage space that meets the first user's set of requirements, collaborative storage program 112 suggests subletting from the one user. In an embodiment, if collaborative storage program 112 determines that one user does not have a storages pace that meets the first user's set of requirements, collaborative storage program 112 suggests subletting from multiple users.

In an embodiment, if collaborative storage program 112 determines that a currently not available storage space would be a suitable storage space for the first user, collaborative storage program 112 suggests alternative storage spaces for renters of the currently not available storage space to move their product to, so that the first user can utilize the currently not available storage space for their product.

In step 330, collaborative storage program 112 sends a contract for the suitable storage space to the first user and a second user. In an embodiment, collaborative storage program 112 generates a contract for the suitable storage space. In an embodiment, collaborative storage program 112 includes a pricing model in the contract. In an embodiment, collaborative storage program 112 sends the contract for the suitable storage space to the first user and a second user, who is the owner of the suitable storage space. In an embodiment, collaborative storage program 112 sends the contract for the suitable storage space while keeping each user anonymous to the other respective user. For example, collaborative storage program 112 sends a generated contract for the suitable storage space to a product manager of company A computing device 120, through user interface 122, that was looking for additional storage space and a warehouse manager of company B computing device 130, through user interface 132, who had extra storage space to rent out. The contract sent to the product manager of company A keeps company B anonymous and the contract sent to the warehouse manager of company B keeps company A anonymous.

In decision 340, collaborative storage program 112 determines whether both the first user and the second user signed the contract. In an embodiment, collaborative storage program 112 determines whether both parties to the contract have signed the contract by seeing if both parties have uploaded a signed contract back to collaborative storage program 112. In an embodiment, collaborative storage program 112 enables each party to the contract to accept or reject the contract through respective user interfaces.

If collaborative storage program 112 determines at least one of the first user and the second user did not sign the contract (decision 340, NO branch), collaborative storage program 112 proceeds to step 350. In step 350, collaborative storage program 112 requests feedback from the or more parties that did not sign the contract. Feedback requested includes a reason for the rejection to better understand the rejecting party's priorities and what the rejecting party is looking for. In an embodiment, collaborative storage program 112 stores the feedback received, e.g., in database 114, and uses the feedback in determining another storage space option for the rejecting party and, in general, for future users requesting storage spaces. Once collaborative storage program 112 receives the feedback and stores the feedback, collaborative storage program 112 proceeds back to step 320 to determine a new suitable storage space using the feedback.

If collaborative storage program 112 determines both the first user and the second user did sign the contract (decision 340, YES branch), collaborative storage program 112 proceeds to step 360. In step 360, responsive to the contract ending, collaborative storage program 112 requests feedback from both parties to the contract. Feedback at this stage includes feedback about the contract itself, the storage space used, and the other party to the contract.

In step 370, collaborative storage program 112 stores the feedback. In an embodiment, collaborative storage program 112 stores the feedback received from both parties to the contract. In an embodiment, collaborative storage program 112 stores the feedback received, e.g., in database 114, and uses the feedback to improve collaborative storage program 112 in determining a suitable storage space in step 320.

FIG. 4 depicts a block diagram of components of computing device 400, suitable for server 110 and/or user computing device 120 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Computing device 400 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Programs may be stored in persistent storage 408 and in memory 406 for execution and/or access by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Programs may be downloaded to persistent storage 408 through communications unit 410.

I/O interface(s) 412 allows for input and output of data with other devices that may be connected to server 110, company A computing device 120, and/or company B computing device 130. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A computer-implemented method for a collaborative leasing system comprising:
receiving, by one or more computer processors, a request for storage space for a product from a first user, wherein the request includes a set of requirements for the storage space;
comparing, by the one or more processors, storage space information for a plurality of storage spaces to the set of requirements;
determining, by the one or more processors, that, individually, none of the plurality of storage spaces meet the set of requirements;
determining, by the one or more processors, at least two suitable storage spaces for the first user based on the comparison and a current demand for the product;
generating, by the one or more processors, a contract between the first user and users associated with the at least two suitable storage spaces for the at least two suitable storage spaces;
sending, by the one or more processors, the contract to the first user and the users while keeping each user anonymous to each other respective user;
determining, by the one or more processors, whether the first user and the users accepted the contract; and
requesting, by the one or more processors, feedback from the first user and the users about the contract.

2. The computer-implemented method of claim 1, further comprising:
responsive to the first user opting into the collaborative leasing system, requesting, by the one or more processors, first storage space information from the first user, wherein the first storage space information includes storage space preferences and first cost preferences; and
creating, by the one or more processors, a user profile for the first user with the first storage space information.

3. The computer-implemented method of claim 2, further comprising:
responsive to the users opting into the collaborative leasing system, requesting, by the one or more processors, storage space information from each of the users, wherein the storage space information includes an inventory of storage space available, preferences for each storage space, and cost preferences; and
creating, by the one or more processors, user profiles for each of the users with the storage space information.

4. The computer-implemented method of claim 3, wherein determining the at least two suitable storage spaces for the first user is further based on the first storage space information and the storage space information.

5. The computer-implemented method of claim 4, further comprising:
completing, by the one or more processors, a cost assessment based on the first cost preferences and the cost preferences.

6. The computer-implemented method of claim 1, wherein requesting the feedback from the first user and the users about the contract comprises:
responsive to determining that the first user and the users accepted the contract and upon completion of the contract, requesting, by the one or more processors, the feedback from the first user and the users, wherein the feedback requested includes feedback on the contract, the suitable storage space, and each respective other party to the contract.

7. The computer-implemented method of claim 1, wherein requesting the feedback from the first user and the users about the contract comprises:
responsive to determining that at least one of the first user and the users did not accept the contract, requesting, by the one or more processors, the feedback from the at least one of the first user and the users, wherein the feedback requested is a reason for not accepting the contract; and
using, by the one or more processors, the feedback to determine alternative suitable storage space for the first user.

8. A computer program product for a collaborative leasing system comprising:
one or more computer readable storage media and program instructions collectively stored on the one or more computer readable storage media, the stored program instructions comprising:
program instructions to receive a request for storage space for a product from a first user, wherein the request includes a set of requirements for the storage space;
program instructions to compare storage space information for a plurality of storage spaces to the set of requirements;
program instructions to determine that, individually, none of the plurality of storage spaces meet the set of requirements;
program instructions to determine at least two suitable storage spaces for the first user based on the comparison and a current demand for the product;
program instructions to generate a contract between the first user and users associated with the at least two suitable storage spaces for the at least two suitable storage spaces;
program instructions to send the contract to the first user and the users while keeping each user anonymous to each other respective user;
program instructions to determine whether the first user and the users accepted the contract; and
program instructions to request feedback from the first user and the users about the contract.

9. The computer program product of claim 8, further comprising:
responsive to the first user opting into the collaborative leasing system, program instructions to request first storage space information from the first user, wherein the first storage space information includes storage space preferences and first cost preferences; and
program instructions to create a user profile for the first user with the first storage space information.

10. The computer program product of claim 9, further comprising:
responsive to the users opting into the collaborative leasing system, program instructions to request storage space information from each of the users, wherein the storage space information includes an inventory of storage space available, preferences for each storage space, and cost preferences; and
program instructions to create user profiles for each of the users with the storage space information.

11. The computer program product of claim 10, wherein the program instructions to determine the at least two suitable storage spaces for the first user are further based on the first storage space information and the storage space information.

12. The computer program product of claim 11, further comprising:
program instructions to complete a cost assessment based on the first cost preferences and the cost preferences.

13. The computer program product of claim 8, wherein the program instructions to request the feedback from the first user and the users about the contract comprise:
responsive to determining that the first user and the users accepted the contract and upon completion of the contract, program instructions to request the feedback from the first user and the users, wherein the feedback requested includes feedback on the contract, the suitable storage space, and each respective other party to the contract.

14. The computer program product of claim 8, wherein the program instructions to request the feedback from the first user and the users about the contract comprise:
responsive to determining that at least one of the first user and the users did not accept the contract, program instructions to request the feedback from the at least one of the first user and the users, wherein the feedback requested is a reason for not accepting the contract; and
program instructions to use the feedback to determine alternative suitable storage space for the first user.

15. A computer system for a collaborative leasing system comprising:
one or more computer processors;
one or more computer readable storage media;
program instructions collectively stored on the one or more computer readable storage media for execution by at least one of the one or more computer processors, the stored program instructions comprising:
program instructions to receive a request for storage space for a product from a first user, wherein the request includes a set of requirements for the storage space;
program instructions to compare storage space information for a plurality of storage spaces to the set of requirements;
program instructions to determine that, individually, none of the plurality of storage spaces meet the set of requirements;
program instructions to determine at least two suitable storage spaces for the first user based on the comparison and a current demand for the product;
program instructions to generate a contract between the first user and users associated with the at least two suitable storage spaces for the at least two suitable storage spaces;
program instructions to send the contract to the first user and the users while keeping each user anonymous to each other respective user;
program instructions to determine whether the first user and the users accepted the contract; and
program instructions to request feedback from the first user and the users about the contract.

16. The computer system of claim 15, further comprising:
responsive to the first user opting into the collaborative leasing system, program instructions to request first storage space information from the first user, wherein the first storage space information includes storage space preferences and first cost preferences; and
program instructions to create a user profile for the first user with the first storage space information.

17. The computer system of claim 16, further comprising:
responsive to the users opting into the collaborative leasing system, program instructions to request storage space information from each of the users, wherein the storage space information includes an inventory of storage space available, preferences for each storage space, and cost preferences; and
program instructions to create user profiles for each of the users with the storage space information.

18. The computer system of claim 17, wherein the program instructions to determine the at least two suitable storage spaces for the first user are further based on the first storage space information and the storage space information.

19. The computer system of claim 18, further comprising:
program instructions to complete a cost assessment based on the first cost preferences and the cost preferences.

20. The computer system of claim 15, wherein the program instructions to request the feedback from the first user and the users about the contract comprise:
responsive to determining that at least one of the first user and the users did not accept the contract, program instructions to request the feedback from the at least one of the first user and the users, wherein the feedback requested is a reason for not accepting the contract; and
program instructions to use the feedback to determine alternative suitable storage space for the first user.
